(19) United States
(12) Patent Application Publication
(10) Pub. No.: US 2023/0144226 A1
(43) Pub. Date: May 11, 2023

(54) Unlimited Vocal Health

(71) Applicant: Katherine Irene Powell, Las Vegas, NV (US)

(72) Inventor: Katherine Irene Powell, Las Vegas, NV (US)

(21) Appl. No.: 17/521,140

(22) Filed: Nov. 8, 2021

(51) Int. Cl. G09B 15/00

(52) U.S. Cl. CPC G09B 15/00

(57) ABSTRACT

A voice training method for a singer includes three main steps of establishing a vocal foundation, establishing correct vocal placement and establishing correct vocal space through selective control of abdominal muscles, soft palate, mouth and jaw of the singer. The voice training method trains the singer and/or speaker in performing powerful vocal sounds without causing vocal damage such as vocal strain, vocal fatigue, inflammation of vocal cords, scarring of vocal cords, or the like.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vocal training of existing art and more specifically relates to a vocal training method for preventing vocal damage.

### RELATED ART

Vocal damage such as vocal strain and vocal fatigue often results in partial or complete loss of voice. This is particularly prevalent in individuals who use their voice regularly under stress, such as singers who sing for lengthy amounts of time in high pitches, and speakers who speak for lengthy amounts of time at high volumes. However, vocal damage is not inevitable amongst these individuals; the vocal damage is usually caused due to poor singing and/or poor speaking technique.

Vocal damage is an obvious impediment to anyone but is a particular hindrance to singers and speakers as they are often unable to perform until the vocal damage is healed; and if they do carry on performing, the damage will not heal and may even become worse. Thus, vocal damage can not only affect the individual physically, but can also develop into a financial and emotional problem if the individual is unable to work or pursue their hobby for a period of time. It is therefore desirable for singers and speakers to protect their voice such that proper performance may occur. There is currently no quick fix for vocal damage, and as such, an obvious need exists for preventing vocal damage from happening in the first place.

### SUMMARY OF THE INVENTION

In view of the foregoing disadvantages inherent in the known vocal training art, the present disclosure provides a novel method of vocal training. The general purpose of the present disclosure, which will be described subsequently in greater detail, is to provide a vocal training method to prevent, or at least substantially prevent, vocal damage such as vocal strain, vocal fatigue, inflammation of vocal cords, scarring of vocal cords, or the like.

A vocal training method for a singer is disclosed herein. The vocal training method may include establishing a vocal foundation by: taking a first breath, thereby relaxing abdominal muscles of the singer and allowing lungs of the singer to expand on each inhalation of the first breath taken by the singer; causing a contraction the abdominal muscles of the singer immediately at a performance of a vocal sound allowing the abdominal muscles to absorb an initial impact of sound production; maintaining the contraction of the abdominal muscles stomach during the performance of the vocal sound until a second breath is taken; and releasing the contraction of the abdominal muscles of the singer during the first breath thereby allowing the lungs to expand again upon the second breath.

Further steps may include establishing correct vocal placement by: placing a soft palate of the singer in a neutral position thereby causing nasal passageways of the singer to become unobstructed; and establishing correct vocal space by: performing the vocal sound in a high pitch; widening the mouth of the singer when ascending in pitch during the performance of the vocal sound in the high pitch; lowering the lower jaw of the singer; and wherein the singer maintains the soft palate in the neutral position throughout the performance of the vocal sound.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, methods of vocal training and improvement, constructed and operative according to the teachings of the present disclosure.

FIG. 1 is a flow chart illustrating a vocal training method for a singer according to an embodiment of the disclosure.

FIG. 2A is a side view of the singer with abdominal muscles tightened according to an embodiment of the disclosure.

FIG. 2B is a side view of a singer with abdominal muscles relaxed according to an embodiment of the disclosure.

FIG. 3A is a side view of the singer with a soft palate in a raised (incorrect) position according to an embodiment of the disclosure.

FIG. 3B is a side view of the singer with the soft palate in a neutral (correct) position according to an embodiment of the disclosure.

FIG. 4A is a front view of the singer with a mouth widened according to an embodiment of the disclosure.

FIG. 4B is a front view of the singer with a lower jaw lowered and the mouth widened according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to vocal training and more particularly to a vocal training method for performing vocal techniques. The vocal training methods may prevent vocal damage such as vocal strain, vocal fatigue, inflammation of vocal cords, scarring of vocal cords, or the like.

A vocal training method is performed by a singer to prevent, or at least substantially prevent, vocal damage to the singer. For example, the vocal training method may prevent vocal strain, loss of voice due to singing, etc. Further, it should be appreciated that whilst a singer is used in the present disclosure as an exemplary subject for the vocal training method, the vocal training method is not limited to performance solely by singers. For example, the vocal training method may be utilized by any individual who uses their voice often—such as public speakers. As such, the terms “singer”, “singing”, “song”, etc. used here and throughout are given for the sake of clarity and the present disclosure is not intended to be limited to these specific terms utilized herein.

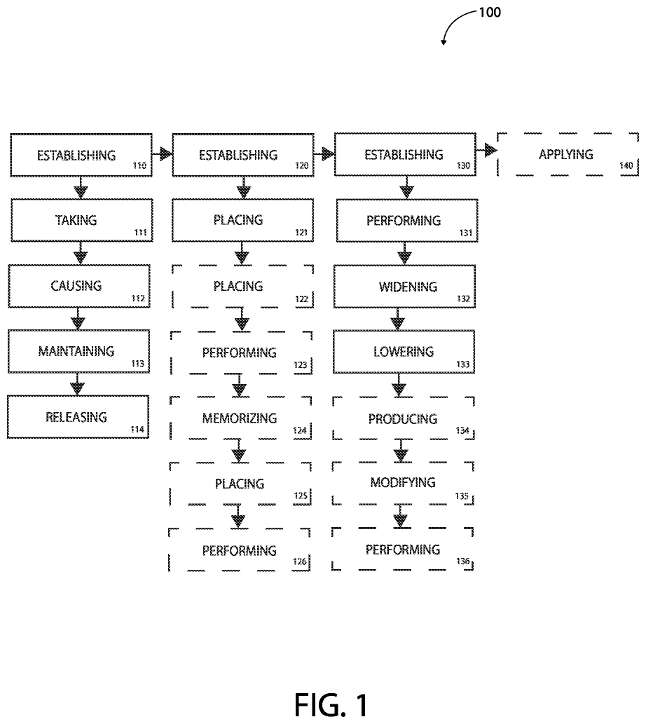

Referring now more specifically to the drawings by numerals of reference, there is shown in FIGS. 1-4B, a vocal training method 100. As shown in FIG. 1, the vocal training method 100 may preferably be defined by three main steps: establishing 110 a vocal foundation; establishing correct vocal placement 120; and establishing 130 correct vocal space. Preferably, the step of establishing 120 correct vocal placement may occur after the step of establishing 110 a vocal foundation and prior to the step of establishing 130 correct vocal space. It is contemplated that the step of establishing 110 a vocal foundation always be the first step of the vocal training method 100. A solid vocal foundation, or “vocal core power” is required in order to create a healthy singing and speaking voice. The solid vocal foundation should support vocal sounds of the singer 5.

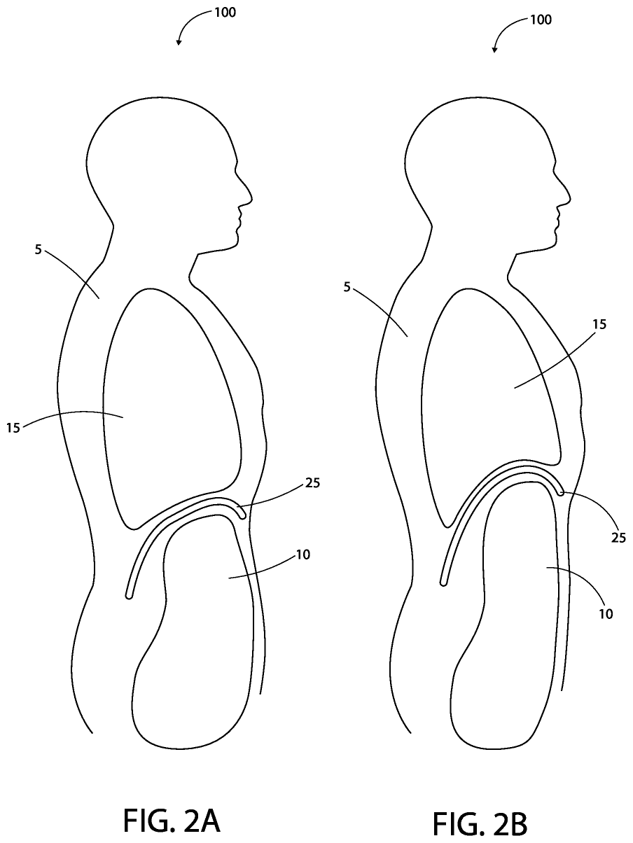

Establishing 110 a vocal foundation may be firstly achieved by taking 111 a first breath. Preferably, the at least one breath may be a ‘relaxed’ breath—a deep (and slow) breath. As illustrated in FIG. 2A, the first breath may relax abdominal muscles 10 of the singer 5 and allow lungs 15 of the singer 5 to expand on each inhalation of the first breath taken by the singer 5, caused due to contraction of a diaphragm 25 of the singer 5, increasing space in the chest cavity into which the lungs 15 may expand and air may enter.

A next step, as illustrated in FIG. 2B, may involve causing 112 a contraction of the abdominal muscles 10 of the singer 5 immediately at performance of a vocal sound (the vocal sound may be a full song, a word, a sentence, etc.), thereby allowing the abdominal muscles 10 to absorb an initial impact of sound production. This contraction may be performed by lengthening and/or straightening a torso such that the singer 5 is standing straight and contracting the abdominal muscles 10 such that their stomach appears tighter. In addition, the contraction 112 of the abdominal muscles 10 may also involve the singer 5 tensing their abdominal muscles 10 as if bracing for impact. The contraction of the abdominal muscles 10 may be an abrupt movement—not a gradual movement; the step should quickly tighten the abdominal muscles 10 and engage the diaphragm 25 of the singer 5, caused when the diaphragm 25 relaxes and moves up into a chest cavity of the singer 5.

It should be appreciated that the term “abdominal muscles” used here and throughout is considered to cover any and all abdominal muscles 10 used in the inhalation and, particularly, the exhalation process of humans. For example, the rectus abdominis, internal and external obliques, transversus abdominis, internal intercostals, etc.

Allowing the abdominal muscles 10 to take the initial impact of the sound production may protect vocal cords of the singer 5 and provide the vocal sound with a boost of power and support. If the abdominal muscles 10 were not tightened at the initial impact of the performance of the vocal sound, the vocal cords would take the initial impact and may knock together. Repeated knocking together of the vocal cords may lead to inflammation, scarring, nodules, polyps, and the like, resulting in vocal damage such as vocal strain, voice loss and/or vocal fatigue. The boost of power provided by tightening the abdominal muscles 10 may prevent the vocal cords from straining and may allow the singer 5 to create additional volume.

A next step of maintaining 113 the contraction of the abdominal muscles 10 during the performance of the vocal sound until a second breath is taken may allow the singer 5 to regulate an amount of the air that is expelled from the lungs 15 when singing, thus allowing the singer 5 to sustain the vocal sounds for longer without running out of air too quickly. Further, maintaining 113 the contraction of the abdominal muscles 10 may provide the singer 5 with improved control of staying in pitch. Releasing 114 the contraction of the abdominal muscles 10 during the first allows the lungs to expand again upon the second breath. For example, if the vocal sound is a full song, the singer 5 may plan breaths and as above, to achieve a powerful foundation, the singer 5 may release the contraction, relaxing their abdominal muscles 10 and gain as much lung capacity as possible to perform for as long as possible.

Establishing 120 correct vocal placement may allow singers and speakers to utilize full vocal range without experiencing a break or ‘passaggio’ in their voice (occurring when the singer 5 is not able to sustain a quality of sound transitioning between registers of the voice). Establishing 120 correct vocal placement may first begin with placing 121 a soft palate 30 of the singer in a neutral position 102 (‘correct’ position) thereby causing nasal passageways 35 of the singer to become unobstructed. Further steps of establishing 120 correct vocal placement may include placing 122 the soft palate 30 of the singer in an raised position 101, wherein the raised position 101 includes the soft palate 30 being in a raised position and nasal passageways 35 of the singer being obstructed; performing 123 the vocal sound with the soft palate 30 in the raised position 101; memorizing 124 a feeling of the soft palate 30 being in the raised position 101 until the singer is capable of recognizing when the soft palate 30 is in the raised position 101; placing 125 the soft palate 30 in the neutral position 102; and performing 126 the vocal sound with the soft palate 30 in the neutral position 102.

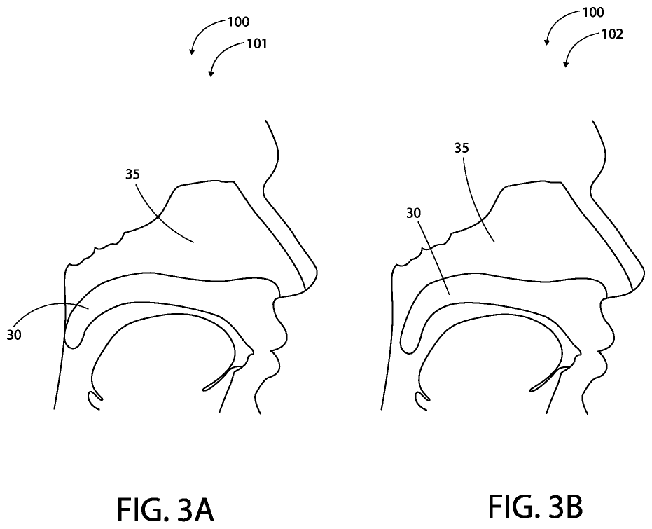

As shown in FIG. 3A, in the raised position 101, nasal passageways 35 of the singer 5 is blocked or obstructed. In the classical technique known in the art, this is what causes ‘chest voice’ or ‘chest register’ (lower tones normally used in speaking) and ‘head voice’ or ‘head register’ (higher tones)—and also causes breaks between them. The chest register in particular may limit the singer 5 in how high of a pitch the singer's voice can reach. For example, in female singers the pitch may be limited to A above middle C; for male singers, the pitch may be limited to F # above middle C. If the singer 5 is able to go higher than these pitches, damage may occur. For example, the damage may include vocal strain, fatigue, inflammation, etc.

As shown in FIG. 3B, in the neutral position 102, the nasal passageways 35 of the singer 5 may be unobstructed. Due to the singer 5 previously memorizing 124 the feeling of the soft palate 30 being in the raised position 101, the singer 5 may automatically remember a feeling of the soft palate 30 being in the neutral position 102, and thus, may instinctively know when the vocal placement is correct. In the neutral position 102, the singer 5 may not experience breaks, the chest voice or the head voice.

In some embodiments, the step of performing 126 the vocal sound with the soft palate 30 in the neutral position 102 may be performed using certain techniques to train the singer 5 in variety and control over pitch and volume of their voice. For example, the step of performing 126 the vocal sound with the soft palate 30 in neutral position may be performed using a belt technique. The belt technique may allow the singer 5 to create a powerful, louder and fuller vocal sound requiring more effort to create and using an elevated volume without experiencing breaks.

In another example, the step of performing 126 the vocal sound with the soft palate 30 in the neutral position 102 may be performed using a mix technique. The mix technique may allow the singer 5 to create a softer, lighter, and somewhat ‘airier’ vocal sound. The mix technique may be used to produce loud or soft vocal sounds; however, the mix technique may require less effort and/or volume than the belt technique requires. Singer 5 utilizing the mix technique may be able to produce vocal sounds using their entire vocal range without experiencing breaks.

In another example, the step of performing 126 the vocal sound with the soft palate 30 in the neutral position 102 may be performed using a mix-like-belt technique. The mix-like-belt technique may combine ease of the mix technique with power of the belt technique. The combination belt and mix technique may be utilized by the singer 5 if a pitch of the vocal sound is very high and would not sound polished using the mix technique. Therefore, the singer 5 may utilize the combination belt and mix technique to perform vocal sounds that sound as if the belt technique is being used (as if the sound is being ‘belted’) even though it is not.

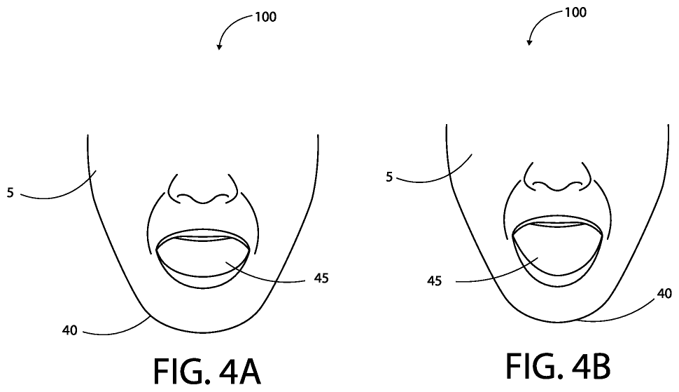

Establishing 130 correct vocal space is important for vocal health, as in order to produce a healthy vocal sound at a higher pitch, an appropriate amount of space needs to exist in a mouth 45 of the singer 5 and the singer 5 must use an appropriate volume. Establishing 130 correct vocal space may include the steps of performing 131 the vocal sound in a high pitch; widening 132 the mouth 45 of the singer 5 when ascending in pitch during the performance of the vocal sound in the high pitch (FIG. 4A); and lowering 133 the lower jaw 40 of the singer 5 (FIG. 4B). The singer 5 may preferably maintain the soft palate 30 in the neutral position 102 throughout the performance of the vocal sound. In the raised (incorrect) position 101 the singer 5 may need to ‘open’ (stretch) a back of their throat by simulating a ‘yawn’; with the soft palate 30 in the neutral position 102, the singer 5 does not need to open the back of their throat and instead creates space in their mouth 45 forward of their molars (rather than behind).

Further, additional steps may be provided for establishing 130 correct vocal space. The additional steps may in particular address vowels and/or consonants that require little vocal space to perform, and as such, can cause problems in pitch and/or volume when performing the particular vowel/consonant. As such, the steps may first include the singer 5 producing 134 a vocal sound requiring minimal vocal space to perform. For example, the word “me” involves little vocal space to say. A next step may then include modifying 135 the vocal sound requiring minimal vocal space to a vocal sound requiring greater vocal space to perform. For example, the singer 5 may take the word “me” and modify a phonetic “ee” sound therein to an “ay” sound.

A next step may include performing 136 the vocal sound requiring greater vocal space. For example, the singer 5 may say “may” instead of “me”. In this example, the singer 5 is not changing the word itself but rather the phonetics of the word. As such, when the singer 5 performs a song having a word such as “me” (or any other vocal sound requiring minimal vocal space to perform) that is particularly troublesome (for example, needs to be sung at high pitch which requires great vocal space), the singer 5 is able to modify the word to perform the word with the higher pitch.

In some embodiments, the vocal training method 100 may further comprise a fourth step of applying 140 a recommended practice. The step of applying 140 a recommended practice may comprise a plurality of optional steps. The singer 5 may choose to perform one of the steps, a combination of some of the steps, or all of the steps. The recommended practice may include one or more of: humming the vocal sounds in a shower; inhaling steam produced from the shower; wearing a neck covering during cool weather and times of high vocal use; drinking room temperature liquids; adding lemon to the room temperature liquids; adding honey to the room temperature liquids; speaking at a higher pitch; avoiding steaming hot liquids; avoiding whispering; avoiding smoking; avoiding ingestion of numbing-medicines; avoiding ingestion of drying-medicines; avoiding making loud said vocal sounds without engaging the abdominal muscles; avoiding ingestion of mucus-producing comestibles; avoiding ingestion of caffeine when sick; avoiding ingestion of sugar when sick; resting when sick; and minimizing coughing as much as possible. It should be appreciated that this list is not exhaustive and that other recommended practices may also be contemplated.

It should be noted that the methods described above include optional steps and may not be implemented in all cases. Optional steps are illustrated using dotted lines in FIG. 1 so as to distinguish them from the other steps. It should also be noted that the steps described in the method of use can be carried out in many different orders according to user preference. Further, under appropriate circumstances, considering such issues as design preference, user preferences, marketing preferences, cost, structural requirements, available materials, technological advances, etc., other vocal training methods are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

The numbered list format used in the claims of the application is used solely for organizational purposes to provide clarity thereto and is not meant to limit in any way the claimed matter nor any aspect of the present disclosure.

What is claimed is:

1. A vocal training method for a singer, the method comprising the steps of:
a) establishing a vocal foundation by:
i) taking a first breath, thereby relaxing abdominal muscles of the singer and allowing lungs of the singer to expand on each inhalation of the at least one breath taken by the singer;
ii) causing a contraction the abdominal muscles of the singer immediately at a performance of a vocal sound allowing the abdominal muscles to absorb an initial impact of sound production;
iii) maintaining the contraction of the abdominal muscles stomach during the performance of the vocal sound until a second breath is taken; and
iv) releasing the contraction of the abdominal muscles of the singer during the first breath thereby allowing the lungs to expand again upon the second breath;
b) establishing correct vocal placement by placing a soft palate of the singer in a neutral position thereby causing nasal passageways of the singer to become unobstructed;
c) establishing correct vocal space by:
i) performing the vocal sound in a high pitch;
ii) widening the mouth of the singer when ascending in pitch during the performance of the vocal sound in the high pitch;
iii) lowering the lower jaw of the singer;
iv) wherein the singer maintains the soft palate in the neutral position throughout the performance of the vocal sound.

2. The vocal training method of claim 1, further comprising the step of establishing vocal placement by:
i) placing a soft palate of the singer in an incorrect position, wherein the incorrect position includes the soft palate being in a raised position and a nasal passageway of the singer being obstructed;
ii) performing the vocal sound with the soft palate in the incorrect position;
iii) memorizing a feeling of the soft palate being in the incorrect position until the singer is capable of recognizing when the soft palate is in the incorrect position;
iv) placing the soft palate in a correct position, wherein the correct position includes the soft palate being in a neutral position and the nasal passageway of the singer being unobstructed; and
v) performing the vocal sound with the soft palate in the correct position.

3. The vocal training method of claim 2 wherein the step of establishing vocal placement occurs after the step of establishing a vocal foundation and prior to the step of establishing correct vocal space.

4. The vocal training method of claim 1, further comprising the steps of:
a) producing the vocal sound requiring minimal vocal space to perform;
b) modifying the vocal sound requiring minimal said vocal space to the vocal sound requiring greater said vocal space to perform; and
c) performing the vocal sound requiring the greater vocal space.

5. The vocal training method of claim 1, further comprising the step of applying a recommended practice selected from the group consisting of:
a) humming the vocal sounds in a shower;
b) inhaling steam produced from the shower;
c) wearing a neck covering during cool weather and times of high vocal use;
d) drinking room temperature liquids;
e) adding lemon to the room temperature liquids;
f) adding honey to the room temperature liquids;
g) speaking at a higher pitch;
h) avoiding steaming hot liquids;
i) avoiding whispering;
j) avoiding smoking;
k) avoiding ingestion of numbing-medicines;
l) avoiding ingestion of drying-medicines;
m) avoiding making loud said vocal sounds without engaging the abdominal muscles;
n) avoiding ingestion of mucus-producing comestibles;
o) avoiding ingestion of caffeine when sick;
p) avoiding ingestion of sugar when sick;
q) resting when sick; and
r) minimizing coughing as much as possible.

6. The vocal training method of claim 1, wherein the contraction of the abdominal muscles is an abrupt movement.

7. The vocal training method of claim 1, wherein the step of performing the vocal sound with the soft palate in the neutral position is performed using a belt technique.

8. The vocal training method of claim 1, wherein the step of performing the vocal sound with the soft palate in the neutral position is performed using a mix technique.

9. The method of claim 1, wherein the step of performing the vocal sound with the soft palate in the neutral position is performed using a mix-like-belt technique.
